(19) United States
(12) Patent Application Publication
(10) Pub. No.: US 2014/0308396 A1
(43) Pub. Date: Oct. 16, 2014

(54) USE OF AMYLASE ENZYME

(71) Applicant: DUPONT NUTRITION BIOSCIENCES APS, Copenhagen (DK)

(72) Inventors: Yandong Liu, Shanghai (CN); Yolanda Guo, Shanghai (CN)

(21) Appl. No.: 14/314,132

(22) Filed: Jun. 25, 2014

Related U.S. Application Data
(63) Continuation-in-part of application No. PCT/EP2012/076969, filed on Dec. 27, 2012.
(60) Provisional application No. 61/645,786, filed on May 11, 2012.

(30) Foreign Application Priority Data
Dec. 26, 2011 (CN) 201110442515.3
Jan. 19, 2012 (CN) 201210017956.3
May 11, 2012 (EP) 12167691.0

(51) Int. Cl. A23B 9/28

(52) U.S. Cl. CPC A23B 9/28
USPC 426/28; 426/7; 426/657

(57) ABSTRACT

The present invention relates to the use of an exoamylase in retarding deterioration of mouthfeel and texture flexibility (softness) in food products comprising animal protein and a starch component.

### RELATED APPLICATIONS AND INCORPORATION BY REFERENCE

This application is a continuation-in-part application of international patent application Serial No. PCT/EP2012/076969 filed Dec. 27, 2012, which published as PCT Publication No. WO 2013/098338 on Jul. 4, 2013, which claims benefit of U.S. application Ser. No. 61/645,786 filed May 11, 2012, and which claims benefit European patent application Serial No. 12167691.0 filed May 11, 2012, Chinese patent application Serial Nos. 201110442515.3 filed Dec. 26, 2011 and 201210017956.3 filed Jan. 19, 2012.

The foregoing applications, and all documents cited therein or during their prosecution (“appln cited documents”) and all documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE INVENTION

The present invention relates to the use of an exoamylase in retarding the deterioration of mouthfeel and texture flexibility (softness) in food products which may comprise animal protein and a starch component. The invention further relates to the process for the preparation of a food product containing both animal protein component and a starch component, wherein exogenousamylase enzymes are used to increase the shelf-life of the food product. The present invention further relates to food products obtained by these methods according to the invention.

### BACKGROUND OF THE INVENTION

Very often meat products, such as sausages, meat balls etc. contain a significant component of native starch, such as corn starch. The starch component may account to 10% or more of the complete food product. The starch component may however be gelatinized before, during or after cooking. When freshly prepared, such meat products containing starch will show a moisture mouthfeel and a desirably flexible (soft) texture. However, over time the texture flexibility and mouthfeel will deteriorate. Without being bound to the theory it is contemplated that the change in these characteristics may be affected by staling of the starch component.

WO8400876 relates to food products of an amylaceous character containing heat stable alpha-amylase.

JP63146746 and JP1055160 relates to the prevention of freeze denaturation and improvement of fish meat quality by the addition to the minced fish meat and subsequent freezing of a starch hydrolyzate produced by treating starch with an alpha-amylase.

Citation or identification of any document in this application is not an admission that such document is available as prior art to the present invention.

### SUMMARY OF THE INVENTION

It is an object of embodiments of the invention to provide methods for the preparation of food products containing animal protein, wherein the shelf-life is increased, such as with methods for retarding deterioration of mouthfeel and texture flexibility (softness) of these food products. It is a further object of embodiments to provide food products with increased shelf life and/or with a better moisture mouthfeel and a desirable flexible texture, such as a food product that retains softness over a longer period of time.

It has been found by the present inventor(s) that by treatment of a food product containing both starch and animal protein with an exogenous exoamylase, the deterioration of mouthfeel and texture flexibility (softness) of the food product over time is inhibited or reduced to a state so as to increase the shelf life of the final food product.

So, in a first aspect the present invention relates to a method of preparing a food product with improved shelf life which may comprise animal protein and a starch component, said method which may comprise the steps of
a) mixing an exogenous exoamylase with a composition which may comprise a starch component,
b) processing the mixture obtained under step a) at conditions allowing said exogenous exoamylase to at least partially hydrolyze said starch component,
c) mixing said composition which may comprise a starch component either prior to, simultaneously with, or subsequent to any one of the steps a) or b) with an animal protein component,
d) processing said composition which may comprise animal protein and a starch component obtained after steps a)-c) to obtain said food product with improved shelf life.

In a second aspect the present invention relates to a process for retarding the deterioration of mouthfeel and texture flexibility (softness) in a composition which may comprise animal protein and starch, said process which may comprise the steps of
a) mixing an exogenous exoamylase with a composition which may comprise a starch component,
b) processing the mixture obtained under step a) at conditions allowing said exogenous exoamylase to at least partially hydrolyze said starch component,
c) mixing said composition which may comprise a starch component either prior to, simultaneously with, or subsequent to any one of the steps a), b), or c) with an animal protein component.

In a third aspect the present invention relates to a food product obtained by the methods according to the present invention.

In a further aspect the present invention relates to a composition which may comprise animal protein and starch with reduced deterioration of mouthfeel and texture flexibility (softness) obtained from the process according to the invention.

In a further aspect the present invention relates to the use of an exogenous exoamylase for improving the shelf life in a food product which may comprise animal protein and a starch component.

In a further aspect the present invention relates to the use of an exogenous exoamylase for retarding deterioration of mouthfeel and texture flexibility (softness) in a food product which may comprise animal protein and a starch component.

Accordingly, it is an object of the invention to not encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. §112, first paragraph) or the EPO (Article 83 of the EPC), such that Applicants reserve the right and hereby disclose a disclaimer of any previously described product, process of making the product, or method of using the product.

It is noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the invention.

These and other embodiments are disclosed or are obvious from and encompassed by, the following Detailed Description.

### BRIEF DESCRIPTION OF THE DRAWINGS

The following detailed description, given by way of example, but not intended to limit the invention solely to the specific embodiments described, may best be understood in conjunction with the accompanying drawings.

FIG. 1 illustrates in a process flow diagram how the food products according to the present invention are prepared and how the process is carried out.

FIG. 2 shows the texture analysis results obtained in example 1.

FIG. 3 shows the texture analysis results obtained in example 3.

FIG. 4 shows the anti-staling effects of four amylases on corn starch; 1c: control-corn starch; 2c: control-(corn starch:tapioca starch=1:1); 3c: control-tapioca starch; 4c: control-corn starch and texture improver; 3: POWERFresh@Bread 8100-200 ppm; 4: POWERFresh@Bread 8100-400 ppm; 5: Novamyl 10000 BG-200 ppm; 6: Novamyl 10000 BG-400 ppm; 7: Opticake Fresh 50 BG-100 ppm; 8: Opticake Fresh 50 BG-200 ppm; 9: Opticake Fresh 50 BG-300 ppm; 10: Opticake Fresh 50 BG-400 ppm; 11: 1271608-25 ppm; 12: 1271608-50 ppm; 13: 1271608-75 ppm; 14: 1271608-100 ppm.

### DETAILED DESCRIPTION OF THE INVENTION

In accordance with this detailed description, the following abbreviations and definitions apply. It should be noted that as used herein, the singular forms “a,” “an,” and “the” include plural referents unless the context clearly dictates otherwise. Thus, for example, reference to “an enzyme” includes a plurality of such enzymes, and reference to “the formulation” includes reference to one or more formulations and equivalents thereof known to those skilled in the art, and so forth. Unless defined otherwise, all technical and scientific terms used herein have the same meaning as commonly understood by one of ordinary skill in the art. The following terms are provided below.

As used herein the term “exogenous” refers to an amylase that is not naturally (or endogenously) contained in the starch component. The term includes an amylase, which may be naturally expressed within a certain starch component, such as in insignificant amounts, but which is added to the starch component, such as in a purified form or in an excessive amount. In some embodiments the exogenous amylase is not known to be expressed in the given starch component.

As used herein “amylase” refers to an enzyme that is capable of catalyzing the degradation of starch.

As used herein the terms “exoamylase” and “exo-acting amylase” refers to any amylase capable hydrolyzing a starch molecule from the non-reducing end of the substrate.

As used herein the terms “exo alpha-amylase” and “exo-acting alpha-amylase” refers to any alpha-amylase capable hydrolyzing alpha 1,4-bonds in a starch molecule from the non-reducing end of the substrate.

Suitable exoamylases include exoamylases that hydrolyzes alpha-1,4-glycosidic bonds from the non-reducing end of a, preferably outer, polysaccharide chain.

In one embodiment suitable exoamylases include beta-amylases (EC 3.2.1.2), which works from the non-reducing end of a glucan polysaccharide catalyzing hydrolysis of α-1,4 glycosidic bonds to remove successive beta-maltose units. Other suitable beta-amylase are those releasing oligosaccharides in β-configuration such as dimers, trimers, tetramers, pentamers or hexamers. In particular amylases releasing dimers and hexamers, such as maltose or maltohexaose residues in β-configuration are useful. One suitable β-amylase is Diazyme BBA (Danisco A/S) or the maltogenic β-amylase producible by Bacillus strain NCIB 11608 as disclosed in EP 234 858, which reference is hereby incorporated herein by reference.

In another embodiment suitable exoamylases include glucoamylases (EC 3.2.1.3, gamma-amylases, amyloglucosidases), which works from the non-reducing end of a glucan polysaccharide catalyzing hydrolysis of α-1,4 glycosidic bonds to remove successive beta-D-glucose units.

In another embodiment suitable exoamylases include glucan 1,4-alpha-maltotetraohydrolase (EC 3.2.1.60), which works from the non-reducing end of a glucan polysaccharide catalyzing hydrolysis of α-1,4 glycosidic bonds to remove successive maltotetraose units. These exoamylases are also called G4 amylases or maltotetraose-forming maltotetrahydrolase, terms that may be used interchangeably. G4 amylase may be derived from Pseudomonas stutzeri, Pseudomonas saccharophila, and Bacillus circulans. Suitable examples of exo-maltotetraohydrolases from Pseudomonas saccharophila and P. stutzeri is disclosed in EP0298645, hereby incorporated by reference. Another suitable enzyme preparation with G4 exoamylase activity is POWERFresh@Bread 8100 Bakery Enzyme (Material number 1271729 Danisco A/S). Other suitable exoamylases that may be used in the methods according to the present invention are any one specific exoamylase specifically disclosed in any one of International Patent Application with publication number WO2010133644, U.S. Pat. No. 7,776,576, and U.S. Pat. No. 7,833,770, which references are incorporated herein by reference.

In another embodiment suitable exoamylases include glucan 1,4-α-maltohydrolase (EC 3.2.1.133), which may also be referred to as a maltogenic α-amylase or an 1,4-α-D-glucan α-maltohydrolase, which works from the non-reducing end of a glucan polysaccharide catalyzing hydrolysis of α-1,4 glycosidic bonds to remove successive alpha-maltose units. Suitable example of glucan 1,4-α-maltohydrolase is disclosed in WO9950399, WO1991004669, U.S. Pat. No. 4,598,048, U.S. Pat. No. 4,604,355, U.S. Pat. No. 6,890,572 and WO2010133644, incorporated herein by reference. Suitable examples of glucan 1,4-α-maltohydrolases are derived from the genus Bacillus, such as from Bacillus stearothermophilus. One specific example of a suitable enzyme preparation is Novamyl 10000 BG.

In another embodiment suitable exoamylases include glucan 1,4-alpha-maltohexaosidase (EC 3.2.1.98), which works from the non-reducing end of a glucan polysaccharide catalyzing hydrolysis of α-1,4 glycosidic bonds to remove successive maltohexaose units. These exoamylases are also called G6-amylase. Examples of exo-maltohexaohydrolases from Bacillus sp. #707 is disclosed in Tsukamoto et al., Biochem. Biophys. Res. Commun.; exo-maltohexaohydrolases from B. circulans F2 is disclosed in Taniguchi, ACS Symp., 1991, Ser. 458, 111-124 and exo-maltohexaohydrolases from Aerobacter aerogenes is disclosed in Kainuma et al., Biochim. Biophys. Acta, 1975, 410, 333-346 all included by reference.

In another embodiment suitable exoamylases include exomaltopentaohydrolase, which works from the non-reducing end of a glucan polysaccharide catalyzing hydrolysis of α-1,4 glycosidic bonds to remove successive maltohpentaose units. Examples of exo-maltopentaohydrolases from an alkaliphilic Gram-positive bacterium is disclosed in U.S. Pat. No. 5,204,254 and exo-maltopentaohydrolases from Pseudomonas sp. is disclosed in Shida et al., Biosci. Biotechnol. Biochem., 1992, 56, 76-80; all included by reference.

In some embodiments, the exoamylases to be used according to the present invention is not an alpha-amylase derived from an Aspergillus genus, such as Aspergillus Oryzae, or Aspergillus Niger.

In some embodiments, the exoamylases to be used according to the present invention is not an isoamylase derived from a Pseudomonas genus, such as Pseudomonas amyloderamosa.

It is to be understood that exoamylases to be used according to the present invention may also possess some degree endo-amylase activity, as long as it has a dominating exo-activity.

In one embodiment the exoamylase to be used according to the invention has an exo-activity which is higher than the endo-activity as measured by the assays described in further detail in the examples, such as the Betamyl and Phadebas assay.

In another embodiment the exoamylase to be used according to the invention has an exo-activity which is at least 10%, such as at least 20%, such as at least 30%, such as at least 40%, such as at least 50%, such as at least 60%, such as at least 70%, such as at least 80%, such as at least 90%, such as at least 95%, such as at least 97%, such as at least 99% the total amylase activity.

The exoamylases to be used according to the invention may suitably be derived from a microbial source or from a plant.

Suitable amylases generating malto-oligosaccharides of a specific degree of polymerisation (DP) including maltohexaose may be derived from several micoorganisrns, such as Klebsiella pneumonia, Bacillus subtilis, B. circulans G-6, B. circulans F-2, and B. caldovelox.

Accordingly, maltopentaose-producing amylases may be derived from B. licheniformis 584 and Pseudomonas spp., maltotetraose-producing amylases from Pseudomonas stutzeri NRRL B-3389, Bacillus sp. MG-4 and Pseudomonas sp. IMD353 and maltotriose-producing amylases from Streptomyces griseus NA-468 and B. subtilis.

EP298645 describes a process for preparing exo-maltotetraohydrolase of Pseudomonas stutzeri or P. saccharophila using genetic engineering techniques. U.S. Pat. No. 5,204,254 describes a native and a genetically modified exo-maltopentaohydrolase of an alkalophilic bacterium (DSM 5853). Other suitable amylases to be used according to the present invention include amylases from Bacillus sp. H167 producing maltohexaose, from a bacterial isolate (163-26, DSM 5853) producing maltopentaose, from Bacillus sp. IMD370 producing maltotetraose and smaller malto-oligosaccharides, and from Bacillus sp. GM 8901 that initially produced maltohexaose from starch which was converted to maltotetraose during extended hydrolysis periods. Suitable beta-amylases may also be derived from plants, such as extracted from soy bean.

Another example of a non-maltogenic exoamylase suitable for use according to the invention is the exoamylase from an alkalophilic Bacillus strain, GM8901.

The enzyme preparation used in the methods according to the present invention is optionally in the form of a granulate or agglomerated powder. The preparation can have a narrow particle size distribution with more than 95% (by weight) of the particles in the range from 25 to 500 μm. Granulates and agglomerated powders may be prepared by conventional methods, e.g., by spraying the exoamylase enzyme onto a carrier in a fluid-bed granulator. The carrier may consist of particulate cores having a suitable particle size. The carrier may be soluble or insoluble, e.g., a salt (such as NaCl or sodium sulfate), a sugar (such as sucrose or lactose), a sugar alcohol (such as sorbitol), starch, rice, corn grits, or soy.

In some embodiments the exoamylase enzyme used in the methods and processes according to the present invention is thermostable.

As used herein the term “thermostable” relates to the ability of the enzyme to retain activity after exposure to elevated temperatures. Preferably, the exoamylase enzyme is capable of degrading starch at temperatures of from about 55° C. to about 80° C. or more. Suitably, the enzyme retains its activity after exposure to temperatures of up to about 95° C.

The thermostability of an enzyme such as a non-maltogenic exoamylase is measured by its half life. Thus, the exoamylase enzyme used according to the methods of the present invention may have long half lives, preferably at elevated temperatures of from 55° C. to about 95° C. or more, preferably at about 80° C.

As used here, the half life (t½) is the time (in minutes) during which half the enzyme activity is inactivated under defined heat conditions. In preferred embodiments, the half life is assayed at 80 degrees C. Preferably; the sample is heated fir 1-10 minutes at 80° C. or higher. The half life value is then calculated by measuring the residual amylase activity, by any of the methods described here. Preferably, a half life assay is conducted as described in more detail in the Examples.

Preferably, the exoamylase enzyme used according to the present invention is active at temperatures above 80° C. and hydrolyse starch during and after the gelatinization of the starch granules which starts at temperatures of about 55 degrees C. The more thermostable the non-maltogenic exoamylase is the longer time it can be active and thus the more antistaling effect it will provide. However, during enzymatic incubation above temperatures of about 85 degrees C., enzyme inactivation can take place. If this happens, the non-maltogenic exoamylase may be gradually inactivated so that there is substantially no activity after the process in the final food product or composition which may comprise starch. Therefore preferentially the non-maltogenic exoamylases suitable for use as described have an optimum temperature above 50 degrees C. and below 98 degrees C.

The thermostability of the exoamylase enzyme used according to the present invention can be improved by using protein engineering to become more thermostable and thus better suited for the uses described here; we therefore encompass the use of variant exoamylase enzymes modified to become more thermostable by protein engineering.

Preferably, the exoamylase enzyme used according to the present invention is pH stable; more preferably. As used herein the term “pH stable” relates to the ability of the enzyme to retain activity over a wide range of pHs. Preferably, the exoamylase enzyme used according to the present invention is capable of degrading starch at a pH of from about 5 to about 10.5. In one embodiment, the degree of pH stability may be assayed by measuring the half life of the enzyme in specific pH conditions. In another embodiment, the degree of pH stability may be assayed by measuring the activity or specific activity of the enzyme in specific pH conditions. The specific pH conditions may be any pH from pH5 to pH10.5.

It is known that some exoamylases can have some degree of endoamylase activity.

Exo-specificity can usefully be measured by determining the ratio of total amylase activity to the total endoamylase activity. This ratio is referred to in this document as a “Exo-specificity index”. In preferred embodiments, an enzyme is considered an exoamylase if it has a exo-specificity index of 2 or more, i.e., its total amylase activity (including exo-amylase activity) is 2 times or more greater than its endoamylase activity. In preferred embodiments, the exo-specificity index of exoamylases is 5 or more, 10 or more, 20 or more 30 or more, 40 or more, 50 or more, 60 or more, 70 or more, 80 or more, 90 or more, or 100 or more. In highly preferred embodiments, the exo-specificity index is 150 or more, 200 or more, 300 or more, 400 or more, 500 or more or 600 or more.

The total amylase activity and the endoamylase activity may be measured by any means known in the art. For example, the total amylase activity may be measured by assaying the total number of reducing ends released from a starch substrate. Alternatively, the use of a Betamyl assay is described in further detail in the Examples, and for convenience, amylase activity as assayed in the Examples.

Endoamylase activity may be assayed by use of a Phadebas Kit (Pharmacia and Upjohn). This makes use of a blue labelled crosslinked starch (labelled with an azo dye); only internal cuts in the starch molecule release label, while external cuts do not do so. Release of dye may be measured by spectrophotometry. Accordingly, the Phadebas Kit measures endoamylase activity, and for convenience, the results of such an assay are referred to in this document as “Phadebas units”.

In a highly preferred embodiment, therefore, the exo-specificity index is expressed in terms of Betamyl Units/Phadebas Units, also referred to as “B/Phad”.

Exo-specificity may also be assayed according to the methods described in the prior art, for example, in our International Patent Publication Number WO99/50399. This measures exo-specificity by way of a ratio between the endoamylase activity to the exoamylase activity. Thus, in a preferred aspect, the exoamylase enzyme used according to the present invention will have less than 0.5 endoamylase units (EAU) per unit of exoamylase activity. Preferably the exoamylase enzyme used according to the present invention have less than 0.05 EAU per unit of exoamylase activity and more preferably less than 0.01 EAU per unit of exoamylase activity.

The exoamylase enzyme used according to the present invention will preferably have exospecificity, for example measured by exospecificity indices, as described above, consistent with their being exoamylases.

As used herein the term. “starch” refers to any material which may comprise complex polysaccharide carbohydrates of plants, such as corn, which may be comprised of amylose and amylopectin with the formula (C₆H₁₀O₅)_{X}, where X can be any number. The term “granular starch” refers to raw, i.e., uncooked starch, e.g., starch that has not been subject to gelatinization.

The starch may suitably be from cereals or pseudo cereals such as corns, wheat, barley, rye, oats, buckwheat and rice; root vegetables such as potatoes, sweet potatoes, cassava, arrowroot, polynesian arrowroot; beans, such as favas, lentils, mung beans, peas, and chickpeas. Other sources of starch include sago, tapioca, sorghum, banana, arracacha, breadfruit, canna, colacasia, katakuri, kudzu, malanga, millet, oca, taro, chestnuts, water chestnuts, yams, cobs and acorns. Those of skill in the art are well aware of available methods that may be used to prepare starch substrates for use in the processes disclosed herein. For example, a useful starch substrate may be obtained from tubers, roots, stems, legumes, cereals or whole grain. More specifically, the granular starch comes from plants that produce high amounts of starch. For example, granular starch may be obtained from corns, cobs, wheat, barley, rye, milo, sago, cassava, tapioca, sorghum, rice, peas, bean, banana, or potatoes. Corn contains about 60-68% starch; barley contains about 55-65% starch; millet contains about 75-80% starch; wheat contains about 60-65% starch; and polished rice contains 70-72% starch. Specifically contemplated starch substrates are corn starch, wheat starch, and barley starch. The starch from a grain may be ground or whole and includes corn solids, such as kernels, bran and/or cobs. The starch may be highly refined raw starch or feedstock from starch refinery processes. Various starches also are commercially available. For example, corn starch is available from Cerestar, Sigma, and Katayama Chemical Industry Co. (Japan); wheat starch is available from Sigma; sweet potato starch is available from Wako Pure Chemical Industry Co. (Japan); and potato starch is available from Nakaari Chemical Pharmaceutical Co. (Japan).

The starch substrate can be a crude starch from milled whole grain, which contains non-starch fractions, e.g., germ residues and fibers. Milling may comprise either wet milling or dry milling. In wet milling, whole grain is soaked in water or dilute acid to separate the grain into its component parts, e.g., starch, protein, germ, oil, kernel fibers. Wet milling efficiently separates the germ and meal (i.e., starch granules and protein) and is especially suitable for production of syrups. In dry milling, whole kernels are ground into a fine powder and processed without fractionating the grain into its component parts. Dry milled grain thus may comprise significant amounts of non-starch carbohydrate compounds, in addition to starch. Most ethanol comes from dry milling. Alternatively, the starch to be processed may be a highly refined starch quality, for example, at least about 90%, at least 95%, at least 97%, or at least 99.5% pure.

The term “composition which may comprise a starch component” means any suitable composition which may comprise starch. The term includes any product that contains or is based on or is derived from starch. Typically, the composition which may comprise a starch component contains or is based on or is derived from starch obtained from flour, such as wheat flour. The term “flour” as used herein is a synonym for the finely-ground meal of any starch source in particular cereal grains such as wheat, corn and/or rice. Preferably, however, the term means flour obtained from corn, rice, potato or wheat. However, compositions which may comprise flour derived from other types of cereals such as for example from rye, barley, and durra are also contemplated. The flour or starch may also be a mixture of flours or starched from different sources in particular from corn, rice, potato and/or wheat.

Those of skill in the art are well aware of available methods that may be used to prepare starch substrates for use in the processes disclosed herein. For example, a useful starch substrate may be obtained from tubers, roots, stems, legumes, cereals or whole grain. More specifically, the granular starch comes from plants that produce high amounts of starch. For example, granular starch may be obtained from corns, cobs, wheat, barley, rye, milo, sago, cassava, tapioca, sorghum, rice, peas, bean, banana, or potatoes. Corn contains about 60-68% starch; barley contains about 55-65% starch; millet contains about 75-80% starch; wheat contains about 60-65% starch; and polished rice contains 70-72% starch. Specifically contemplated starch substrates are cornstarch, wheat starch, and barley starch. The starch from a grain may be ground or whole and includes corn solids, such as kernels, bran and/or cobs. The starch may be highly refined raw starch or feedstock from starch refinery processes. Various starches also are commercially available. For example, cornstarch is available from Cerestar, Sigma, and Katayama Chemical Industry Co. (Japan); wheat starch is available from Sigma; sweet potato starch is available from Wako Pure Chemical Industry Co. (Japan); and potato starch is available from Nakaari Chemical Pharmaceutical Co. (Japan).

Maltodextrins are useful as starch substrates in embodiments of the present invention. Maltodextrins may comprise starch hydrolysis products having about 20 or fewer dextrose (glucose) units. Typical commercial maltodextrins contain mixtures of polysaccharides including from about three to about nineteen linked dextrose units. Maltodextrins are defined by the FDA as products having a dextrose equivalence (DE) of less than 20. They are generally recognized as safe (GRAS) food ingredients for human consumption. Dextrose equivalence (DE) is a measure of reducing power compared to a dextrose (glucose) standard of 100. The higher the DE, the greater the extent of starch depolymerization, resulting in a smaller average polymer polysaccharide) size, and the greater the sweetness. A particularly useful maltodextrin is MALTRIN® M040 obtained from cornstarch, available from Grain Processing Corp. (Muscatine, Iowa): DE 4.0-7.0; bulk density 0.51 g/cc; measured water content 6.38% by weight.

The starch substrate can be a crude starch from milled whole grain, which contains non-starch fractions, e.g., germ residues and fibers. Milling may comprise either wet milling or dry milling. In wet milling, whole grain is soaked in water or dilute acid to separate the grain into its component parts, e.g., starch, protein, germ, oil, kernel fibers. Wet milling efficiently separates the germ and meal (i.e., starch granules and protein) and is especially suitable for production of syrups. In dry milling, whole kernels are ground into a fine powder and processed without fractionating the gain into its component parts. Dry milled grain thus may comprise significant amounts of non-starch carbohydrate compounds, in addition to starch. Most ethanol comes from dry milling. Alternatively, the starch to be processed may be a highly refined starch quality, for example, at least about 90%, at least 95%, at least 97%, or at least 99.5% pure.

As used herein the term “animal protein component” refers to the protein or protein containing compositions derived from part of flesh, whole meat muscle, or parts thereof derived from any animal including bovine/beef, porcine/pork, turkey, duck, goose, game bird, chicken, poultry, sheep, horse, goat, wild game, rodents, sea food or shell fish, such as shrimp, fish and combinations thereof. In some embodiments “animal protein” refers to the part of the flesh or whole meat muscle including a low fraction of fat and tendons. Alternatively the term may refer to a more purified fraction of animal protein purified from the flesh or whole meat muscle. Eggs and milk as well as compositions derived from eggs and milk, although containing a significant proportion of protein, are according to the present invention referred to as “non-animal protein components”.

Representative suitable fish, wherein animal protein may be derived from include deboned flounder, sole, haddock, cod, sea bass, salmon, tuna, trout or the like. Representative suitable shell fish include shelled shrimp, crabmeat, crayfish, lobster, scallops, oysters, or shrimp in the shell or the like. Representative suitable meats, wherein animal protein may be derived from include ham, beef, lamb, pork, venison, veal, buffalo or the like, poultry such as chicken, mechanically deboned poultry meat, turkey, duck, a game bird or goose or the like either in fillet form or in ground form such as hamburgers. The meats can include the bone of the animal when the bone does not adversely affect the edibility of the meat such as spare ribs, lamb chops or pork chops.

Unless otherwise indicated the weight or weight percentage of the animal protein component is given by its total weight of the fresh flesh or meat with its natural water content, which may be as high as 65%.

Unless otherwise indicated the salt content of the animal protein component is given by its natural salt content, which may be about 1.5%. In some embodiment the total amount of salt is kept below 10% in the composition being treated with exogenous amylase enzyme.

The food products produced by the methods according to the present invention are typically minced meat products. The minced meat products may be any food that utilizes minced meat as a raw material, for example, hamburgers, patties, meat balls, coarse cut sausages, shishkebabs, shao-mais, dumplings, and the like. In particular, the present invention can be highly useful for the production of food products, such as hamburgers, patties, coarse cut sausages, etc. which may suffer from roast shrinkage and require an appropriate hardness or softness and heterogenous feeling based on the minced meat.

Other food products according to the present invention include sausages and sausage composition, hot dog compositions, sliceable meat products and spreadable meat products, including, but not limited to, ground beef, sausages, frankfurters, wieners (hot dogs), bologna, and lunch meat.

Sausages prepared according to the methods of the present invention are the broad class of meat products prepared from any suitable animal meat and include pork sausage (loose or cased, breakfast style or country style), hot dogs (wieners), frankfurters, metts, bratwurst, knockwurst, bockwurst, bologna, summer sausage, braunschweiger, liver sausages, luncheon meats, boiled ham, minced ham, dutch loaf salami, Polish-style sausage, chopped pork and beef, and meat loaf. The preparation of sausages may essentially follow the normal preparation methods for the full-fat meat products, requiring the addition of up to about 10% of adjuvant materials, except that a starch component treated with an exoamylase is added or mixed with the animal protein component.

In addition to the nature of the food product with animal protein and a starch component, the food products may be processed in a myriad of final forms in accordance with their desired uses. They may be prepared in chunks or pieces for use in soups, sauces, and the like. They may be precooked, frozen, freeze-dried, canned, packaged in pouches, or combinations of these. They may also be formed into portions and sold to the consumer who may then formulate them into the shape most suitable for his or her needs.

The food product containing animal protein, such as a sausage or a hot dog composition containing meat, such as chicken, beef or fish, may also include herbs such as sage, spices, carbohydrates/sugar or sweetener, pepper, dietary fibres, salt and fillers, such as dairy products, which products are all well known in the art.

A variety of additional ingredients may also be added to any of the food product according to the invention. For example, emulsifiers, non-animal proteins, other enzymes, hydrocolloids, flavouring agents, oxidising agents, minerals and vitamins, antioxidants, antimicrobial agents, and combinations thereof may be included. Antioxidant additives include BHA, BHT, TBHQ, vitamins A, C and E and derivatives thereof, and various plant extracts such as those containing carotenoids, tocopherols or flavonoids having antioxidant properties, may be included to increase the shelf-life or nutritionally enhance the animal meat compositions. The antioxidants and the antimicrobial agents may have a combined presence at levels of from about 0.01% to about 10%, preferably, from about 0.05% to about 5%, and more preferably from about 0.1% to about 2%, by weight of the protein-containing materials that will be extruded.

Fats or oils, such as animal fat or any suitable animal or plant oil, such as coconut oil, corn oil, rape oil, lard, or fish oil may also be added to the food products and compositions according to the present invention. The meat to fat ratio in the food product is dependent upon the style, but the fat content is usually limited to a maximum of 30%, 35% or 50%, by weight, depending on the style.

Other ingredients that may be added to the food product and compositions according to the present invention includes grains, spices, such as pepper, ginger, paprika, nutmeg, mace, thyme, allspice, onion, garlic, coriander, cardamon, caraway, sage, laurel, marjoram, clove, or cinnamon. The spices may be used in any state; raw, dried, powder, extract, concentrated extract, or emulsion; preservatives, such as sodium erythorbate, sodium nitrite, sorbic acid or potassium sorbinate); colorants, stabilisers including thickening polysaccharides such as xanthan gum, gellan gum, guar gum, carrageenan, pectin, tragacanth gum and konjak mannan, and starch; and emulsifiers.

An emulsifier may suitably be contained in an amount of 0.01 to 5%, such as 0.05 to 3%. Examples of the emulsifier include various kinds of non-meat protein components, such as egg proteins, soybean proteins, gluten soy, milk proteins, proteins separated from these proteins and (partially) decomposed products of these proteins, sucrose fatty acid esters, sorbitan fatty acid esters, polyoxyethylene sorbitan fatty acid esters, glycerol fatty acid monoesters, polyglycerol fatty acid esters, polyglycerol condensed ricinoleic acid esters, glycerol organic acid fatty acid esters, propylene glycol fatty acid esters, lecithin and enzymatically decomposed lecithin.

Suitable emulsifiers include sodium casemates, lecithin, polyoxyethylene stearat, mono- and diglycerides of edible fatty acids, acetic acid esters of mono- and diglycerides of edible fatty acids, lactic acid esters of mono- and diglycerides of edible fatty acids, citric acid esters of mono- and diglycerides of edible fatty acids, diacetyl tartaric acid esters of mono- and diglycerides of edible fatty acids, sucrose esters of edible fatty acids, sodium stearoyl-2-lactylate, and calcium stearoyl-2-lactylate.

A non-animal protein may suitably be contained in an amount of 0.01 to 5%, such as 0.05 to 3%. Examples of non-animal proteins include various kinds of non-meat protein components, such as egg proteins, soybean proteins, gluten soy, milk proteins, proteins separated from these proteins and (partially) decomposed products of these proteins, and the like, as well as combinations thereof.

The process for the preparation of the food product according to the present invention may essentially follow standard procedures for the preparation of such food product.

Accordingly, e.g. a sausage may be made from ground meat (normally pork, beef, chicken, turkey), mixed with the enzyme treated starch component, salt, herbs, and other spices. It may be stuffed and formed into a tabular casing traditionally made from intestine, but may also be synthetic. The sausage may be cooked as part of the processing and the casing may be removed afterwards. Sausages may be preserved by curing, drying, or smoking.

The methods according to the present invention require that an exogenous exoamylase is allowed to work on a composition which may comprise a starch component. At some stage in the process this amylase treated starch component is mixed with a component which may comprise the animal protein. In some embodiments the animal protein component and the composition which may comprise a starch component are mixed prior to or simultaneously with the addition of the exoamylase. Alternatively, the composition which may comprise a starch component is treated with the exoamylase before this treated composition is mixed with the animal protein component.

Unless otherwise indicated, a specific temperature used in the process according to the present invention refers to the core temperature of the mixture or composition. This is measured by standard techniques known to the person skilled in the art. Accordingly, if the exoamylase used in the process is to be inactivated, the core temperature of the food product components should preferably be held at, the denaturing temperature of the exoamylase for a certain amount of time, preferably at least 1° C., at least 3° C., at least 5° C. or at least 10° C. above the denaturing temperature. A suitable temperature for most exoamylases is 95° C. The specific time and temperature may of course vary with the specific enzyme and composition used, which enzymes differs in stability towards elevated temperatures.

For the commercial and home food production, it is important to use an appropriate level of exoamylase activity in the composition which may comprise starch. A level of activity that is too high may result in a product that is too sticky and/or doughy and therefore unmarketable.

Temperature control such as cooling may be used as part of the process for the control of microbial growth.

Temperature and pH may be optimized according to the specific exoamylase used in the process. In addition to temperature and pH other factors, such as ionic strength, can affect the enzymatic reaction. Each of these physical and chemical parameters are well known to the person skilled in the art and may be considered and optimized in order for an enzymatic reaction to be accurate and reproducible.

As used herein, “optimum pH” means the pH at which the exoamylase disclosed herein displays the highest activity in a standard assay for amylase activity, measured over a range of pH's.

As described above the present invention relates to a method of preparing a food product with improved shelf life which may comprise animal protein and a starch component, the method which may comprise the steps of a) mixing an exogenous exoamylase with a composition which may comprise a starch component, b) processing the mixture obtained under step a) at conditions allowing the exogenous exoamylase to at least partially hydrolyze the starch component, c) mixing the composition which may comprise a starch component either prior to, simultaneously with, or subsequent to any one of the steps a) or b) with an animal protein component, and d) processing the composition which may comprise animal protein and a starch component obtained after steps a)-c) to obtain the food product with improved shelf life.

It is to be understood that in some specific embodiments according to the present invention, the mixing of the composition which may comprise a starch component with an animal protein component may be performed either prior to or simultaneously with any one of the steps a) or b), (i.e. the mixing and processing with an exogenous exoamylase) in the method described above.

The invention also relates to a process for retarding deterioration of mouthfeel and texture flexibility (softness) in a composition which may comprise animal protein and starch, said process which may comprise the steps of a) mixing an exogenous exoamylase with a composition which may comprise a starch component, b) processing the mixture obtained under step a) at conditions allowing said exogenous exoamylase to at least partially hydrolyze said starch component, and c) mixing said composition which may comprise a starch component either prior to, simultaneously with, or subsequent to any one of the steps a), b), or c) with an animal protein component.

In some embodiments the methods according to the invention further which may comprise a step of processing the mixture obtained under step b) to inactivate said exogenous exoamylase. In some embodiments this inactivation is by heat treatment, such as by treatment for more than 2 minutes, such as 4, 6, 8, 10, 12, 14, 16, 18, 20, 25, or 30 minutes at a temperature not more than 10° C., such as 8° C., such as 6° C., such as 4° C. from the denaturing temperature of said exogenous exoamylase, or alternative at a temperature 95° C. for more than 2 minutes, such as 4, 6, 8, 10, 12, 14, 16, 18, 20, 25, or 30 minutes.

In some embodiments the exoamylase is added in an amount of 100-5000 ppm, such as 200-4000 ppm, such as 200-4000 ppm, such as 300-3000 ppm, such as 400-2000 ppm, such as 500-1000 ppm, of the starch component.

It is to be understood that the exoamylase may not only have exoamylase activity. The enzyme may also have more or less endoamylase activity. Accordingly, in some embodiments the exoamylase is added in an amount of ppm adjusted according to the percentage of exoamylase activity exhibited by the specific exoamylase used in the methods according to the present invention. Thus, if an exoamylase is mentioned to be used in an amount of 100 ppm and the exoamylase activity only accounts for 50% of the amylase activity, 200 ppm of total exoamylase may be used.

In some embodiments the processing temperature under step b) is 30° C. to 60° C., such as 35° C. to 60° C., 40° C. to 60° C., 45° C. to 60° C., or 50° C. to 60° C., such as a temperature not more than 10° C., such as 8° C., 6° C., or 4° C. from the temperature optimum of said exogenous exoamylase.

In some embodiments the processing pH under step b) is in the range of 4-8, such in the range of 5-7, such as pH not more than 0.5, 1, 1.5 from the pH optimum pH of said exogenous exoamylase.

In some embodiments the shelf life of the food product is improved as measured by a lower maximum breaking force 1 day, such as 2 days, such as 3 days, such as 4 days, such as 5 days, such as 6 days, such as 7 days, such as 9 days, such as 11 days, such as 14 days, such as 16 days, such as 18 days, such as 20 days, such as 21 days, such as 24 days, such as 26 days, such as 27 days, such as 28 days, such as 30 days, such as 32 days, such as 34 days, such as 35 days, such as 6 weeks, such as 7 weeks, such as 8 weeks, such as 9 weeks, such as 10 weeks after preparation of the food product.

In some embodiments the retarding of deterioration of mouthfeel and texture flexibility (softness) is measured as a lowering of the maximum breaking force it day, such as 2 days, such as 3 days, such as 4 days, such as 5 days, such as 6 days, such as 7 days, such as 9 days, such as 11 days, such as 14 days, such as 16 days, such as 18 days, such as 20 days, such as 21 days, such as 24 days, such as 26 days, such as 27 days, such as 28 days, such as 30 days, such as 32 days, such as 34 days, such as 35 days, such as 6 weeks, such as 7 weeks, such as 8 weeks, such as 9 weeks, such as 10 weeks after preparation of the composition which may comprise animal protein and starch.

In some embodiments the maximum breaking force of the food product or composition which may comprise animal protein and starch as compared to the same product prepared without the use of an exogenous exoamylase is reduced by at least 5%, such as at least 10%, such as at least 15%, such as at least 20%, such as at least 25%, such as at least 30%, such as at least 35%, such as at least 40%, such as at least 45%, such as at least 50%, such as at least 55%, such as at least 60%, such as at least 65%, such as at least 70%, such as at least 75%, such as at least 80%, such as at least 85%, such as at least 90%, such as at least 95%, such as at least 100%.

In some embodiments the shelf life of the food product is improved as measured by a lower maximum breaking force as compared to the same food product prepared without the use of an exogenous exoamylase, measured at least about 5 days, such as 10 days, such as 15 days, such as 20 days, such as 25 days, such as 30 days, such as 35 days, such as 40 days, such as 45 days, such as 50 days, such as 55 days, such as 60 days after the preparation of the food product.

In some embodiments the retarding of deterioration of mouthfeel and texture flexibility (softness) in the composition which may comprise animal protein and starch is improved as measured by a tower maximum breaking force as compared to the same product prepared without the use of an exogenous exoamylase, measured at least about 5 days, such as 10 days, such as 15 days, such as 20 days, such as 25 days, such as 30 days, such as 35 days, such as 40 days, such as 45 days, such as 50 days, such as 55 days, such as 60 days after the preparation of the composition which may comprise animal protein and starch.

In some embodiments the starch component amounts to at least about 4%, such as 6%, such as 8%, such as 10%, such as 12%, such as 14%, such as 16%, such as 18%, such as 20%, such as 22%, such as 24%, such as 26%, such as 28%, such as 30%, such as 32%, such as 36%, such as 38%, such as 40% by weight percent of the final food product.

In some embodiments the starch component amounts to at least about 4%, such as 6%, such as 8%, such as 10%, such as 12%, such as 14%, such as 16%, such as 18%, such as 20%, such as 22%, such as 24%, such as 26%, such as 28%, such as 30%, such as 32%, such as 36%, such as 38%, such as 40% by weight percent of the final composition which may comprise animal protein and starch.

In some embodiments the exoamylase is derived from a strain of the genus Bacillus, such as Bacillus Clausii, from Pseudomonas, such as Pseudomonas saccharophila, such as an exoamylase selected from a G4 amylase, such as POWERFresh@Bread 8100, and a maltogenic α-amylase, such as Novamyl 10000 BG.

In some embodiments the starch component is derived from corn, wheat, potato, sweet potato, tapioca, rice, such as a flour or meal, such as corn flour, maize flour, rice flour, rye meal, rye flour, oat flour, oat meal, soy flour, sorghum meal, sorghum flour, potato meal, or potato flour.

In some embodiments the animal protein is derived from any one of bovine/beef, porcine/pork, turkey, duck, goose, game bird, chicken, poultry, sheep, horse, goat, wild game, rodents, sea food or shell fish, such as shrimp, fish, and combinations thereof.

In some embodiments the animal protein accounts fir at least about 10% by weight of the final food product, such as at least about 15%, such as at least about 20%, such as at least about 25%, such as at least about 30%, such as at least about 35%, such as at least about 40%, such as at least about 45%, such as at least about 50%, such as at least about 55%, such as at least about 60%, such as at least about 65%, such as at least about 70% of the final food product.

In some embodiments the animal protein accounts for at least about 10% by weight of the final composition which may comprise animal protein and starch, such as at least about 15%, such as at least about 20%, such as at least about 25%, such as at least about 30%, such as at least about 35%, such as at least about 40%, such as at least about 45%, such as at least about 50%, such as at least about 55%, such as at least about 60%, such as at least about 65%, such as at least about 70% of the final composition which may comprise animal protein and starch.

Numbered embodiments of the invention:
1. A method of preparing a food product with improved shelf life comprising animal protein and a starch component, said method comprising the steps of
   a) mixing an exogenous exoamylase with a composition comprising a starch component,
   b) processing the mixture obtained under step a) at conditions allowing said exogenous exoamylase to at least partially hydrolyze said starch component,
   c) mixing said composition comprising a starch component either prior to, simultaneously with, or subsequent to any one of the steps a) or b) with an animal protein component, and
   d) processing said composition comprising animal protein and a starch component obtained after steps a)-c) to obtain said food product with improved shelf
2. The method according to embodiment 1 further comprising a step of processing the mixture obtained under step b) to inactivate said exogenous exoamylase.
3. The method according to embodiment 2, wherein said inactivation is by heat treatment, such as by treatment for more than 2 minutes, such as 4, 6, 8, 10, 12, 14, 16, 18, 20, 25, or 30 minutes at a temperature not more than 10° C., such as 8° C., such as 6° C., such as 4° C. from the denaturing temperature of said exogenous exoamylase, or alternative at a temperature 95° C. for more than 2 minutes, such as 4, 6, 8, 10, 12, 14, 16, 18, 20, 25, or 30 minutes.
4. The method according to any one of embodiments 1-3, wherein the exoamylase is added in an amount of 100-5000 ppm, such as 200-4000 ppm, such as 200-4000 ppm, such as 300-3000 ppm, such as 400-2000 ppm, such as 500-1000 ppm, of the starch component.
5. The method according to any one of embodiments 1-4, wherein the processing temperature under step b) is 30° C. to 60° C., such as 35° C. to 60° C., 40° C. to 60° C., 45° C. to 60° C., or 50° C. to 60° C., such as a temperature not more than 10° C., such as 8° C., 6° C., or 4° C. from the temperature optimum of said exogenous exoamylase.
6. The method according to any one of embodiments 1-5, wherein the processing pH under step b) is in the range of 4-8, such in the range of 5-7, such as pH not more than 0.5, 1, 1.5 from the pH optimum pH of said exogenous exoamylase.
7. The method according to any one of embodiments 1-6, wherein the shelf life of the food product is improved as measured by a lower maximum breaking force 1 day, such as 2 days, such as 3 days, such as 4 days, such as 5 days, such as 6 days, such as 7 days, such as 9 days, such as 11 days, such as 14 days, such as 16 days, such as 18 days, such as 20 days, such as 21 days, such as 24 days, such as 26 days, such as 27 days, such as 28 days, such as 30 days, such as 32 days, such as 34 days, such as 35 days, such as 6 weeks, such as 7 weeks, such as 8 weeks, such as 9 weeks, such as 10 weeks after preparation of the food product.
8. The method according to any one of embodiments 1-7, wherein the maximum breaking force of the food product as compared to the same food product prepared without the use of an exogenous exoamylase is reduced by at least 5%, such as at least 10%, such as at least 15%, such as at least 20%, such as at least 25%, such as at least 30%, such as at least 35%, such as at least 40%, such as at least 45%, such as at least 50%, such as at least 55%, such as at least 60%, such as at least 65%, such as at least 70%, such as at least 75%, such as at least 80%, such as at least 85%, such as at least 90%, such as at least 95%, such as at least 100%.
9. The method according to any one of embodiments 1-8, wherein the shelf life of the food product is improved as measured by a lower maximum breaking force as compared to the same food product prepared without the use of an exogenous exoamylase, measured at least about 5 days, such as 10 days, such as 15 days, such as 20 days, such as 25 days, such as 30 days, such as 35 days, such as 40 days, such as 45 days, such as 50 days, such as 55 days, such as 60 days after the preparation of the food product.
10. The method according to any one of embodiments 1-9, wherein the starch component amounts to at least about 4%, such as 6%, such as 8%, such as 10%, such as 12%, such as 14%, such as 16%, such as 18%, such as 20%, such as 22%, such as 24%, such as 26%, such as 28%, such as 30%, such as 32%, such as 36%, such as 38%, such as 40% by weight percent of the final food product.
11. The method according to any one of embodiments 1-10, wherein the exoamylase is derived from a strain of the genus Bacillus, such as Bacillus Clausii, from Pseudomonas, such as Pseudomonas saccharophila, such as an exoamylase selected from a G4 amylase, such as POWERFresh@Bread 8100 and a maltogenic α-amylase, such as Novamyl 10000 BG.
12. The method according to any one of embodiments 1-11 wherein the starch component is derived from corn, wheat, potato, sweet potato, tapioca, rice, such as a flour or meal, such as corn flour, maize flour, rice flour, rye meal, rye flour, oat flour, oat meal, soy flour, sorghum meal, sorghum flour, potato meal, or potato flour.
13. The method according to any one of embodiments 1-12, wherein said animal protein is derived from any one of bovine/beef, porcine/pork, turkey, duck, goose, game bird, chicken, poultry, sheep, horse, goat, wild game, rodents, sea food or shell fish, such as shrimp, fish, and combinations thereof.
14. The method according to any one of embodiments 1-12, wherein said animal protein accounts for at least about 10% by weight of the final food product, such as at least about 15%, such as at least about 20%, such as at least about 25%, such as at least about 30%, such as at least about 35%, such as at least about 40%, such as at least about 45%, such as at least about 50%, such as at least about 55%, such as at least about 60%, such as at least about 65%, such as at least about 70% of the final food product.
15. A process for retarding the deterioration of mouthfeel and texture flexibility (softness) in a composition comprising animal protein and starch, said process comprising the steps of
   a) mixing an exogenous exoamylase with a composition comprising a starch component,
   b) processing the mixture obtained under step a) at conditions allowing said exogenous exoamylase to at least partially hydrolyze said starch component,
   c) mixing said composition comprising a starch component either prior to, simultaneously with, or subsequent to any one of the steps a), b), or c) with an animal protein component.
16. The process according to embodiment 15 further comprising a step of processing the mixture obtained under step b) to inactivate said exogenous exoamylase.
17. The process according to embodiment 16, wherein said inactivation is by heat treatment, such as by treatment for more than 2 minutes, such as 4, 6, 8, 10, 12, 14, 16, 18, 20, 25, or 30 minutes at a temperature not more than 10° C., such as 8° C., such as 6° C., such as 4° C. from the denaturing temperature of said exogenous exoamylase, or alternative at a temperature 95° C. for more than 2 minutes, such as 4, 6, 8, 10, 12, 114, 16, 18, 20, 25, or 30 minutes.
18. The process according to any one of embodiments 15-17, wherein the exoamylase is added in an amount of 100-5000 ppm, such as 200-4000 ppm, such as 200-4000 ppm, such as 300-3000 ppm, such as 400-2000 ppm, such as 500-1.000 ppm, of the starch component.
19. The process according to any one of embodiments 15-18, wherein the processing temperature under step b) is 30° C. to 60° C., such as 35° C. to 60° C., 40° C., to 60° C., 45° C. to 60° C., or 50° C. to 60° C., such as a temperature not more than 10° C., such as 8° C., 6° C., or 4° C. from the temperature optimum of said exogenous exoamylase.
20. The process according to any one of embodiments 15-19, wherein the processing pH under step b) is in the range of 4-8, such in the range of 5-7, such as pH not more than 0.5, 1, 1.5 from the pH optimum pH of said exogenous exoamylase.
21. The process according to any one of embodiments 15-20, wherein the retarding deterioration of mouthfeel and texture flexibility (softness) is measured as a lowering of the maximum breaking force 1 day, such as 2 days, such as 3 days, such as 4 days, such as 5 days, such as 6 days, such as 7 days, such as 9 days, such as 11 days, such as 14 days, such as 16 days, such as 18 days, such as 20 days, such as 21 days, such as 24 days, such as 26 days, such as 27 days, such as 28 days, such as 30 days, such as 32 days, such as 34 days, such as 35 days, such as 6 weeks, such as 7 weeks, such as 8 weeks, such as 9 weeks, such as 10 weeks after preparation of the composition comprising animal protein and starch.
22. The process according to any one of embodiments 15-21, wherein the maximum breaking force of the composition comprising animal protein and starch as compared to the same product prepared without the use of an exogenous exoamylase is reduced by at least 5%, such as at least 10%, such as at least 15%, such as at least 20%, such as at least 25%, such as at least 30%, such as at least 35%, such as at least 40%, such as at least 45%, such as at least 50%, such as at least 55%, such as at least 60%, such as at least 65%, such as at least 70%, such as at least 75%, such as at least 80%, such as at least 85%, such as at least 90%, such as at least 95%, such as at least 100%.
23. The process according to any one of embodiments 15-22, wherein the retarding deterioration of mouthfeel and texture flexibility (softness) of the composition comprising animal protein and starch is measured by a lower maximum breaking force as compared to the same product prepared without the use of an exogenous exoamylase, measured at least about 5 days, such as 10 days, such as 15 days, such as 20 days, such as 25 days, such as 30 days, such as 35 days, such as 40 days, such as 45 days, such as 50 days, such as 55 days, such as 60 days after the preparation of the composition comprising animal protein and starch.
24. The process according to any one of embodiments 15-23, wherein the starch component amounts to at least about 4%, such as 6%, such as 8%, such as 10%, such as 12%, such as 14%, such as 16%, such as 18%, such as 20%, such as 22%, such as 24%, such as 26%, such as 28%, such as 30%, such as 32%, such as 36%, such as 38%, such as 40% by weight percent of the final composition comprising animal protein and starch.
25. The process according to any one of embodiments 15-24, wherein the exoamylase is derived from a strain of the genus Bacillus, such as Bacillus Clausii, from Pseudomonas, such as Pseudomonas saccharophila, such as an exoamylase selected from a G4 amylase, such as POWERFresh@Bread 8100, and a maltogenic α-amylase, such as Novamyl 10000 BG.
26. The process according to any one of embodiments 15-25, wherein the starch component is derived from corn, wheat, potato, sweet potato, tapioca, rice, such as a flour or meal, such as corn flour, maize flour, rice flour, rye meal, rye flour, oat flour, oat meal, soy flour, sorghum meal, sorghum flour, potato meal, or potato flour.
27. The process according to any one of embodiments 15-26, wherein said animal protein is derived from any one of bovine/beef, porcine/pork, turkey, duck, goose, game bird, chicken, poultry, sheep, horse, goat, wild game, rodents, sea food or shell fish, such as shrimp, fish, and combinations thereof.
28. The process according to any one of embodiments 15-27, wherein said animal protein accounts for at least about 15% by weight of the final composition comprising animal protein and starch, such as at least about 10% by weight of the final food product, such as at least about 15%, such as at least about 20%, such as at least about 25%, such as at least about 30%, such as at least about 35%, such as at least about 40%, such as at least about 45%, such as at least about 50%, such as at least about 55%, such as at least about 60%, such as at least about 65%, such as at least about 70% of the final composition comprising animal protein and starch.
29. food product obtained by the method according to any one of embodiments 1-14.
30. Composition comprising animal protein and starch with reduced deterioration of mouthfeel and texture flexibility (softness) obtained from the process according to any one of embodiments 15-28.
31. Use of an exogenous exoamylase for improving the shelf life in a food product comprising animal protein and a starch component.
32. Use of an exogenous exoamylase for retarding deterioration of mouthfeel and texture flexibility (softness) in a food product comprising animal protein and a starch component.

Although the present invention and its advantages have been described in detail, it should be understood that various changes, substitutions and alterations can be made herein without departing from the spirit and scope of the invention as defined in the appended claims.

The present invention will be further illustrated in the following Examples which are given for illustration purposes only and are not intended to limit the invention in any way.

### Example 1

### Formulation

Sausage Formulation

| | % |
|---|---|
| Chicken breast | 21.81 |
| Salt | 1.69 |
| Tripolyphosphate | 0.25 |
| Ice | 11.88 |
| Blends | 0.57 |
| Colorant | 2.49 |
| Emulsion | 48.19 |
| Soy protein concentrate | 0.99 |
| Sugar | 1.39 |
| Corn starch and amylase | 10.68 |
| HP75 | 0.05 |
| Total | 100.00 |

Blends Formulation

| | |
|---|---|
| MSG (Monosodium | 42.35 |
| Glutamate) | |
| Sodium ascorbate | 19.22 |
| White pepper | 38.43 |
| Total | 100.00 |

Colorant Formulation

| | % |
|---|---|
| Sodium nitrite | 1.14 |
| Water | 98.18 |
| momascusc colours | 0.67 |
| Total | 100.00 |

Emulsion Formulation

| | % |
|---|---|
| Chicken skin | 46.88 |
| Hot water | 45.02 |
| Concentrated soy protein | 5.95 |
| Isolated soy protein | 2.14 |
| Total | 100.00 |

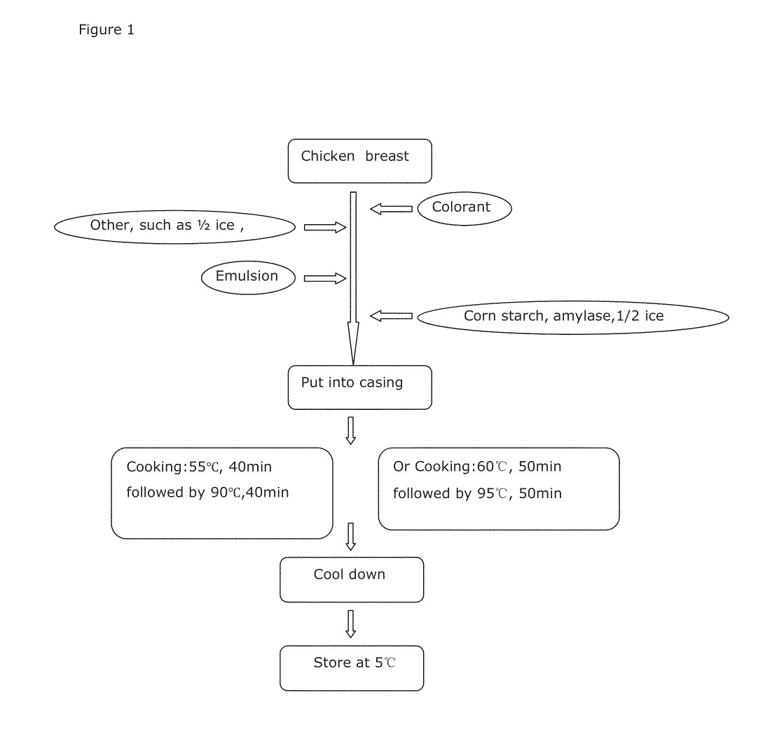

### Processing Flow (See FIG. 1)

Procedure:

a) Chicken breast and chicken skin preparation
The frozen chicken breast and chicken skin were thawed until the temperature was around −4° C. Then these two raw materials were ground before use.

b) Blends preparation
The powder of MSG, Sodium ascorbate and white pepper were mixed well together.

c) Colorant preparation
Sodium nitrite and momascusc colours were dissolved in water.

d) Emulsion preparation
Concentrated soy protein, isolated soy protein and hot water (90° C.) were chopped for 3 min in a 5 L cutter (DADAUX, made in France). Then the pre-ground chicken skin was added to the mixture and was chopped for about 2 min until it became an even emulsion. The final temperature of this emulsion was 13° C. The final temperature may preferably be between 10-14° C.

e) Corn starch and amylase.
Mix corn starch and amylase together

f) Sausage preparation
Firstly, the ground Chicken breast was put into a 5 L cutter (DADAUX, made in France) and chopped for 1 min. Then, the colorant solution, salt and half ice were added to the meat and chopped for 3 min. Then, the emulsion was put into the cutter and chopped for 1 min. Finally, with other ingredients, the mixture of corn starch and amylase was added to the cutter and chopped for 2 min. The temperature of this final mixture should be no more than 10° C. Then the product was put into a casing and cooked. The cooking temperature was 55° C. for 40 min and followed by 90° C. for 40 min. After the sausage was cooled down, it was stored at 5° C.

The exoamylase enzyme was added in an amount of about 100-800 ppm based on the amount of starch. The semi-final amylase containing preparation was treated at 55° C. for 40 minutes. In order to deactivate the amylase enzyme, the preparation was treated at a temperature above 90° C. for 40 min in a final step. Texture analysis method (testing tool: Texture analysis TA.XTplus, from Stable Micro Systems. Ltd, UK).

Sausages were cut into 20 mm in height. TA-XT2 settings were as follows:

| Setting: | Value: | |
|---|---|---|
| pre-test speed | 1.5 | mm/s |
| test speed | 1.1 | mm/s |
| post-test speed | 1.5 | mm/s |
| target mode | strain | |
| strain | 60% | |
| time | 5.0 | s |
| trigger type | auto (force) | |
| trigger force | 5.0 | g |

| | |
|---|---|
| tare mode | auto |
| advanced options | on |

The force to puncture the sausage (breaking force) at which the probe penetrates the sausage before breaking was recorded. Hardness was measured according to the maximum force (breaking force).

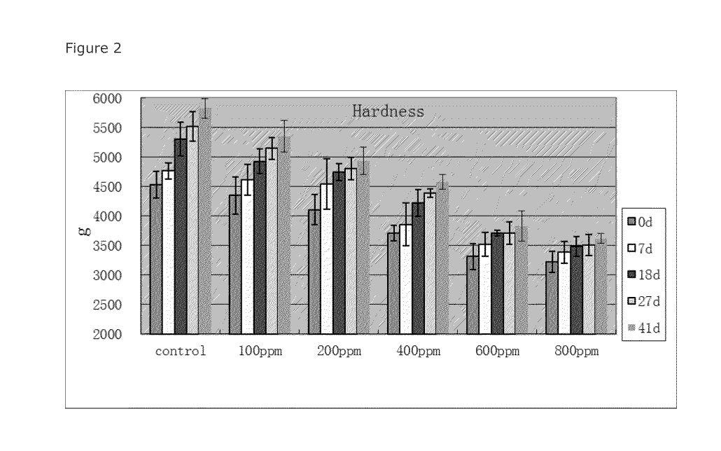

Texture Analysis Results (See FIG. 2)

When exoamylase (G4 amylase, Powerfresh) was added to a sausage, which contained 10% corn starch, the hardness of the sausage decreased with the addition of amylase. The more amylase added, the softer the sausage got. During storage, the sausage became firmer and firmer presumably affected by staling of corn starch. The addition of an exogenous exoamylase could however delay deterioration of mouthfeel and texture flexibility (softness). After 41 days' storage, the sausage with 400 ppm amylase added kept the same hardness as the control. When the dosage of amylase was increased to above 400 ppm, the sausage could keep the hardness below that of the control for a longer time. The amylase had a good effect against deterioration of mouthfeel and texture flexibility (softness) when corn starch was used.

### Example 2

Four different amylase enzymes were used in sausage to test the anti-stalling capability on corn starch. The process was carried out essentially as described in example 1.

The G4 exoamylase POWERFresh@Bread 8100 (Danisco A/S) was tested against Diazyme FA and Bakezyme AN 301 (DSM). Bakezyme AN 301 and Diazyme FA primarily have endoamylase activity, whereas POWERFresh@Bread 8100 primarily have exoamylase activity as required by the present invention.

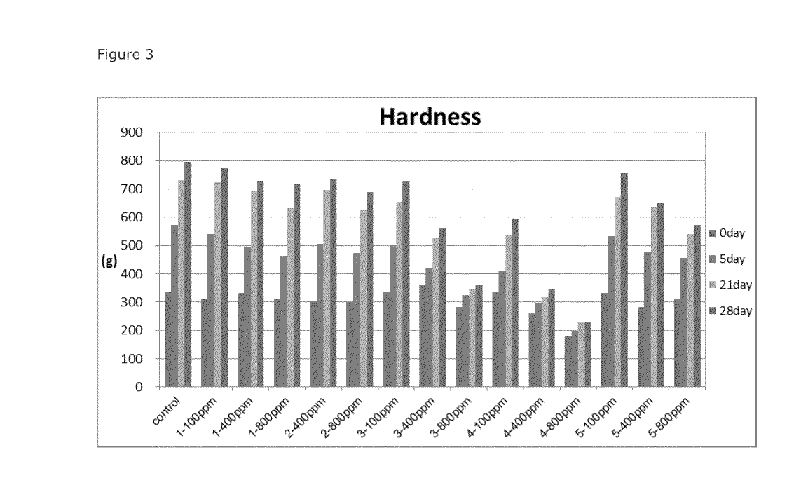

The sausages prepared in this example contained 20% corn starch. Based on corn starch, 800 ppm of each enzyme was used in the sausage. The enzymes were allowed to work at 60° C. for 50 min and thereafter inactivated at 95° C. for 50 min. Texture analysis results (See FIG. 3).

The sausages were stored at 5° C. for one month and the anti-stalling effect was measured with texture analysis. The TA results and sensory results showed that as compared to endoamylase enzymes, the exoamylase POWERFresh@Bread 8100 had good anti-stalling effects.

Texture analysis may be made by means of Texture analysis TA.XTplus, from Stable Micro Systems. Ltd, UK or similar equipment known in the art.

### Example 3

The exoamylase Novamyl 10000 BG (Novozymes A/S) was tested against Diazyme FA and Bakezyme AN 301 (DSM). Bakezyme AN 301 and Diazyme FA primarily have endoamylase activity, whereas Novamyl 10000 BG primarily have exoamylase activity as required by the present invention.

The sausages prepared in this example contained 20% corn starch. Based on corn starch, 800 ppm of each enzyme was used in the sausage. The enzymes were allowed to work at 60° C. for 50 min and thereafter inactivated at 95° C. for 50 min. Texture analysis results (See FIG. 3).

The sausages were stored at 5° C. for one month and the anti-stalling effect was measured with texture analysis. The TA results and sensory results showed that as compared to endoamylase enzymes, the exoamylase Novamyl 10000 BG had good anti-stalling effects.

Texture analysis may be made by means of Texture analysis TA.XTplus, from Stable Micro Systems. Ltd, UK or similar equipment known in the art.

### Example 4

### Alternative Sausage Formulation

Formulation

| | % |
|---|---|
| Chicken breast | 10.00 |
| Salt | 1.69 |
| Tripolyphosphate | 0.25 |
| Ice | 25.42 |
| Blends | 0.57 |
| Colorant | 2.49 |
| Emulsion | 38.19 |
| Sugar | 1.39 |
| Corn starch and amylase | 20.00 |
| Total | 100.00 |

Blends, colorant and emulsion formulation were as described in example 1

Texture analysis results are shown in FIG. 3.

1: Diazyme BRA

2: Diazyme FA

3: POWERFresh@Bread 8100

4: Novamyl 10000 BG

5: Bakezyme AN 301

Five different amylases were tested in the preparation of the sausage, which contained 20% corn starch. For each amylase tested, the relationship between the amylase dosage and anti-staling effects was tested. The sausages were stored at 5° C. for nearly one month and the hardness was tested when the sausage were stored for 0 day (after cooking), 5 day, 21 day and 28 day.

The hardness of the sausages for all enzymes tested and for the control was increasing with time when they stored at 5° C., especially for the first five days. However, when amylase was added into the sausage, the hardness decreased as compared to the control without amylase. The more amylase added, the softer the sausage got. According to texture analysis results and sensory results. Novamyl 10000 BG had best anti-staling effects on corn starch. Meanwhile, POWERFresh @ Bread 8100 also had a good anti-staling capability, even not as good as Novamyl 10000 BG.

### Example 5

### Formulation

Sausage Formulation

| | % |
|---|---|
| Chicken breast | 21.81 |
| Salt | 1.69 |
| Tripolyphosphate | 0.25 |
| Ice | 11.93 |
| Blends | 0.57 |
| Colorant | 2.49 |
| Emulsion | 48.19 |
| CSP | 0.99 |
| Sugar | 1.39 |
| Corn starch | 10.68 |
| Total | 100.00 |

The formulation of emulsion, colorant and blends were the same as example 1.

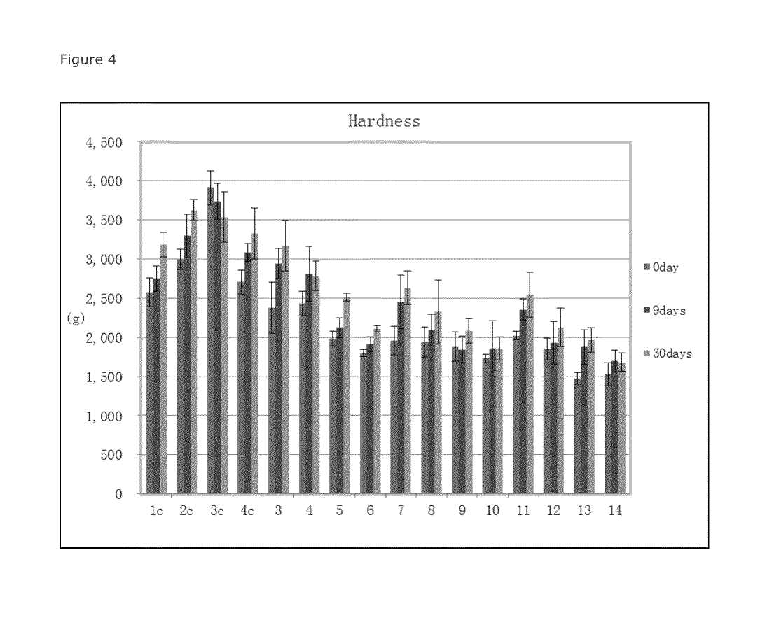

Texture analysis results (See FIG. 4).

As usual, corn starch had staling problems. But modified tapioca starch and the blends of corn starch and modified tapioca starch almost had no staling problems.

These four kinds of amylases all could inhabit the increase of hardness during one-month storage. The more amylase were added, softer the sausage was. They all had anti-staling effects on corn starch in sausage.

At the same dosage, 1271608 had the best anti-staling effects among these four kinds of amylases. And Opticake Fresh 50 BG also had a good anti-staling effect as Novamyl 10000 BG. The anti-staling effects of 1271608, Opticake Fresh 50 BG and Novamyl 10000 BG were better than POWERFresh@Bread 8100.

### Amylase Assays

### Betamyl Assay

One Betamyl unit is defined as activity degrading 0.0351 mmole per 1 min. of PNP-coupled maltopentaose so that 0.0351 mmole PNP per 1 min. can be released by excess alpha-glucosidase in the assay mix. The assay mix contains 50 ul 50 mM Na-citrate, 5 mM CaCl2, pH 6.5 with 25 ul enzyme sample and 25 ul Betamyl substrate (Glc5-PNP and alpha-glucosidase) from Megazyme, Ireland (1 vial dissolved in 10 ml water). The assay mix is incubated for 30 min. at 40 C and then stopped by adding 150 ul 4% Tris. Absorbance at 420 nm is measured using an ELISA-reader and the Betamyl activity is calculate based on Activity=A420*d in Betamyl units/ml of enzyme sample assayed. For dosing in baking trials 1 BMK=1000 Betamyl units are used.

### Endo-Amylase Assayssh2

The endo-amylase assay is identical to the Phadebas assay run according to manufacturer (Pharmacia & Upjohn Diagnostics AB).

### Exo-Specificity

The ratio of exo-amylase activity to Phadebas activity was used to evaluate exo-specificity.

The invention is further described by the following numbered paragraphs:

1. A method of preparing a food product with improved shelf life, such as retarding the deterioration of mouthfeel and texture flexibility (softness), the food product comprising animal protein and a starch component, said method comprising the steps of
e) mixing an exogenous exoamylase with a composition comprising a starch component,
f) processing the mixture obtained under step a) at conditions allowing said exogenous exoamylase to at least partially hydrolyze said starch component,
g) mixing said composition comprising a starch component either prior to, simultaneously with, or subsequent to any one of the steps a) or b) with an animal protein component, and
h) processing said composition comprising animal protein and a starch component obtained after steps a)-c) to obtain said food product with improved shelf life.

2. The method according to paragraph 1 further comprising a step of processing the mixture obtained under step b) to inactivate said exogenous exoamylase.

3. The method according to paragraph 2, wherein said inactivation is by heat treatment, such as by treatment for more than 2 minutes, such as 4, 6, 8, 10, 12, 14, 16, 18, 20, 25, or 30 minutes at a temperature not more than 10° C., such as 8° C., such as 6° C., such as 4° C. from the denaturing temperature of said exogenous exoamylase, or alternative at a temperature 95° C. for more than 2 minutes, such as 4, 6, 8, 10, 12, 14, 16, 18, 20, 25, or 30 minutes.

4. The method according to any one of paragraphs 1-3, wherein the exoamylase is added in an amount of 100-5000 ppm, such as 200-4000 ppm, such as 200-4000 ppm, such as 300-3000 ppm, such as 400-2000 ppm, such as 5001000 ppm, of the starch component.

5. The method according to any one of paragraphs 1-4, wherein the processing temperature under step b) is 30° C. to 60° C., such as 35° C. to 60° C., 40° C. to 60° C., 45° C. to 60° C., or 50° C. to 60° C., such as a temperature not more than 10° C., such as 8° C., 6° C., or 4° C. from the temperature optimum of said exogenous exoamylase.

6. The method according to any one of paragraphs 1-5, wherein the processing pH under step b) is in the range of 4-8, such in the range of 5-7, such as pH not more than 0.5, 1, 1.5 from the pH optimum pH of said exogenous exoamylase.

7. The method according to any one of paragraphs 1-6, wherein the shelf life of the food product is improved as measured by a lower maximum breaking force 1 day, such as 2 days, such as 3 days, such as 4 days, such as 5 days, such as 6 days, such as 7 days, such as 9 days, such as 11 days, such as 14 days, such as 16 days, such as 18 days, such as 20 days, such as 21 days, such as 24 days, such as 26 days, such as 27 days, such as 28 days, such as 30 days, such as 32 days, such as 34 days, such as 35 days, such as 6 weeks, such as 7 weeks, such as 8 weeks, such as 9 weeks, such as 10 weeks after preparation of the food product.

8. The method according to any one of paragraphs 1-7, wherein the maximum breaking force of the food product as compared to the same food product prepared without the use of an exogenous exoamylase is reduced by at least 5%, such as at least 10%, such as at least 15% such as at least 20%, such as at least 25%, such as at least 30%, such as at least 35%, such as at least 40%, such as at least 45%, such as at least 50%, such as at least 55%, such as at least 60%, such as at least 65%, such as at least 70%, such as at least 75%, such as at least 80%, such as at least 85% such as at least 90%, such as at least 95%, such as at least 100%.

9. The method according to any one of paragraphs 1-8, wherein the shelf life of the food product is improved as measured by a lower maximum breaking force as compared to the same food product prepared without the use of an exogenous exoamylase, measured at least about 5 days, such as 10 days, such as 15 days, such as 20 days, such as 25 days, such as 30 days, such as 35 days, such as 40 days, such as 45 days, such as 50 days, such as 55 days, such as 60 days after the preparation of the food product.

10. The method according to any one of paragraphs 1-9, wherein the starch component amounts to at least about 4%, such as 6%, such as 8%, such as 10%, such as 12%, such as 14%, such as 16%, such as 18%, such as 20%, such as 22%, such as 24%, such as 26%, such as 28%, such as 30%, such as 32%, such as 36%, such as 38%, such as 40% by weight percent of the final food product.

11. The method according to any one of paragraphs 1-10, wherein the exoamylase is derived from a strain of the genus Bacillus, such as Bacillus Clausii, from Pseudomonas, such as Pseudomonas saccharophila, such as an exoamylase selected from a G4 amylase, such as an exoamylase specifically disclosed in any one of International Patent application with publication number WO2010133644, U.S. Pat. No. 7,776,576, U.S. Pat. No. 7,833,770, such as the exoamylase of POWERFresh@Bread 8100, and a maltogenic α-amylase, such as Novamyl 10000 BG.

12. The method according to any one of paragraphs 1-11, wherein the starch component is derived from corn, wheat, potato, sweet potato, tapioca, rice, such as a flour or meal, such as corn flour, maize flour, rice flour, rye meal, rye flour, oat flour, oat meal, soy flour, sorghum meal, sorghum flour, potato meal, or potato flour.

13. The method according to any one of paragraphs 1-12, wherein said animal protein is derived from any one of bovine/beef, porcine/pork, turkey, duck, goose, game bird, chicken, poultry, sheep, horse, goat, wild game, rodents, sea food or shell fish, such as shrimp, fish, and combinations thereof.

14. The method according to any one of paragraphs 1-12, wherein said animal protein accounts for at least about 10% by weight of the final food product, such as at least about 15%, such as at least about 20%, such as at least about 25%, such as at least about 30%, such as at least about 35%, such as at least about 40%, such as at least about 45%, such as at least about 50%, such as at least about 55%, such as at least about 60%, such as at least about 65%, such as at least about 70% of the final food product.

15. The process according to any one of paragraphs 1-14, wherein the retarding deterioration of mouthfeel and texture flexibility (softness) is measured as a lowering of the maximum breaking force 1 day, such as 2 days, such as 3 days, such as 4 days, such as 5 days, such as 6 days, such as 7 days, such as 9 days, such as 11 days, such as 14 days, such as 16 days, such as 18 days, such as 20 days, such as 21 days, such as 24 days, such as 26 days, such as 27 days, such as 28 days, such as 30 days, such as 32 days, such as 34 days, such as 35 days, such as 6 weeks, such as 7 weeks, such as 8 weeks, such as 9 weeks, such as 10 weeks after preparation of the composition comprising animal protein and starch.

16. The process according to any one of paragraphs 1-15, wherein the maximum breaking force of the composition comprising animal protein and starch as compared to the same product prepared without the use of an exogenous exoamylase is reduced by at least 5%, such as at least 10%, such as at least 15%, such as at least 20%, such as at least 25%, such as at least 30%, such as at least 35%, such as at least 40%, such as at least 45%, such as at least 50%, such as at least 55%, such as at least 60%, such as at least 65%, such as at least 70%, such as at least 75%, such as at least 80%, such as at least 85%, such as at least 90%, such as at least 95%, such as at least 100%.

17. The process according to any one of paragraphs 1-16, wherein the retarding deterioration of mouthfeel and texture flexibility (softness) of the composition comprising animal protein and starch is measured by a lower maximum breaking force as compared to the same product prepared without the use of an exogenous exoamylase, measured at least about 5 days, such as 10 days, such as 15 days, such as 20 days, such as 25 days, such as 30 days, such as 35 days, such as 40 days, such as 45 days, such as 50 days, such as 55 days, such as 60 days after the preparation of the composition comprising animal protein and starch.Novamyl

18. Composition, such as a food product obtained by the method according to any one of paragraphs 1-17.

19. Use of an exogenous exoamylase for improving the shelf life, such as for retarding deterioration of mouthfeel and texture flexibility (softness) in a food product comprising animal protein and a starch component.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

What is claimed is:

1. A method of preparing a food product with improved shelf life, such as retarding the deterioration of mouthfeel and texture flexibility (softness), the food product comprising animal protein and a starch component, said method comprising the steps of
e) mixing an exogenous exoamylase with a composition comprising a starch component,
f) processing the mixture obtained under step a) at conditions allowing said exogenous exoamylase to at least partially hydrolyze said starch component,
g) mixing said composition comprising a starch component either prior to, simultaneously with, or subsequent to any one of the steps a) or b) with an animal protein component, and
h) processing said composition comprising animal protein and a starch component obtained after steps a)-c) to obtain said food product with improved shelf life.

2. The method according to claim 1 further comprising a step of processing the mixture obtained under step b) to inactivate said exogenous exoamylase.

3. The method according to claim 2, wherein said inactivation is by heat treatment, such as by treatment for more than 2 minutes, such as 4, 6, 8, 10, 12, 14, 16, 18, 20, 25, or 30 minutes at a temperature not more than 10° C., such as 8° C., such as 6° C., such as 4° C. from the denaturing temperature of said exogenous exoamylase, or alternative at a temperature 95° C. for more than 2 minutes, such as 4, 6, 8, 10, 12, 14, 16, 18, 20, 25, or 30 minutes.

4. The method according to claim 1, wherein the exoamylase is added in an amount of 100-5000 ppm, such as 200-4000 ppm, such as 200-4000 ppm, such as 300-3000 ppm, such as 400-2000 ppm, such as 500-1000 ppm, of the starch component.

5. The method according to claim 1, wherein the processing temperature under step b) is 30° C. to 60° C., such as 35° C. to 60° C., 40° C. to 60° C., 45° C. to 60° C., or 50° C. to 60° C., such as a temperature not more than 10° C., such as 8° C., 6° C., or 4° C. from the temperature optimum of said exogenous exoamylase.

6. The method according to claim 1, wherein the processing pH under step b) is in the range of 4-8, such in the range of 5-7, such as pH not more than 0.5, 1, 1.5 from the pH optimum pH of said exogenous exoamylase.

7. The method according to claim 1, wherein the shelf life of the food product is improved as measured by a lower maximum breaking force 1 day, such as 2 days, such as 3 days, such as 4 days, such as 5 days, such as 6 days, such as 7 days, such as 9 days, such as 11 days, such as 14 days, such as 16 days, such as 18 days, such as 20 days, such as 21 days, such as 24 days, such as 26 days, such as 27 days, such as 28 days, such as 30 days, such as 32 days, such as 34 days, such as 35 days, such as 6 weeks, such as 7 weeks, such as 8 weeks, such as 9 weeks, such as 10 weeks after preparation of the food product.

8. The method according to claim 1, wherein the maximum breaking force of the food product as compared to the same food product prepared without the use of an exogenous exoamylase is reduced by at least 5%, such as at least 10%, such as at least 15%, such as at least 20%, such as at least 25%, such as at least 30%, such as at least 35%, such as at least 40%, such as at least 45%, such as at least 50%, such as at least 55%, such as at least 60%, such as at least 65%, such as at least 70%, such as at least 75%, such as at least 80%, such as at least 85%, such as at least 90%, such as at least 95%, such as at least 100%.

9. The method according to claim 1, wherein the shelf life of the food product is improved as measured by a lower maximum breaking force as compared to the same food product prepared without the use of an exogenous exoamylase, measured at least about 5 days, such as 10 days, such as 15 days, such as 20 days, such as 25 days, such as 30 days, such as 35 days, such as 40 days, such as 45 days, such as 50 days, such as 55 days, such as 60 days after the preparation of the food product.

10. The method according to claim 1, wherein the starch component amounts to at least about 4%, such as 6%, such as 8%, such as 10%, such as 12%, such as 14%, such as 16%, such as 18%, such as 20%, such as 22%, such as 24%, such as 26%, such as 28%, such as 30%, such as 32%, such as 36%, such as 38%, such as 40% by weight percent of the final food product.

11. The method according to claim 1, wherein the exoamylase is derived from a strain of the genus Bacillus, such as Bacillus Clausii, from Pseudomonas, such as Pseudomonas saccharophila, such as an exoamylase selected from a G4 amylase, such as an exoamylase specifically disclosed in any one of International Patent application with publication number WO2010133644, U.S. Pat. No. 7,776,576, U.S. Pat. No. 7,833,770, such as the exoamylase of POWERFresh@Bread 8100, and a maltogenic α-amylase, such as Novamyl 10000 BG.

12. The method according to claim 1, wherein the starch component is derived from corn, wheat, potato, sweet potato, tapioca, rice, such as a flour or meal, such as corn flour, maize flour, rice flour, rye meal, rye flour, oat flour, oat meal, soy flour, sorghum meal, sorghum flour, potato meal, or potato flour.

13. The method according to claim 1, wherein said animal protein is derived from any one of bovine/beef, porcine/pork, turkey, duck, goose, game bird, chicken, poultry, sheep, horse, goat, wild game, rodents, sea food or shell fish, such as shrimp, fish, and combinations thereof.

14. The method according to claim 1, wherein said animal protein accounts for at least about 10% by weight of the final food product, such as at least about 15%, such as at least about 20%, such as at least about 25%, such as at least about 30%, such as at least about 35%, such as at least about 40%, such as at least about 45%, such as at least about 50%, such as at least about 55%, such as at least about 60%, such as at least about 65%, such as at least about 70% of the final food product.

15. The process according to claim wherein the retarding deterioration of mouthfeel and texture flexibility (softness) is measured as a lowering of the maximum breaking force 1 day, such as 2 days, such as 3 days, such as 4 days, such as 5 days, such as 6 days, such as 7 days, such as 9 days, such as 11 days, such as 14 days, such as 16 days, such as 18 days, such as 20 days, such as 21 days, such as 24 days, such as 26 days, such as 27 days, such as 28 days, such as 30 days, such as 32 days, such as 34 days, such as 35 days, such as 6 weeks, such as 7 weeks, such as 8 weeks, such as 9 weeks, such as 10 weeks after preparation of the composition comprising animal protein and starch.

16. The process according to claim 1, wherein the maximum breaking force of the composition comprising animal protein and starch as compared to the same product prepared without the use of an exogenous exoamylase is reduced by at least 5%, such as at least 10%, such as at least 15%, such as at least 20%, such as at least 25%, such as at least 30%, such as at least 35%, such as at least 40%, such as at least 45%, such as at least 50%, such as at least 55%, such as at least 60%, such as at least 65%, such as at least 70%, such as at least 75%, such as at least 80%, such as at least 85%, such as at least 90%, such as at least 95%, such as at least 100%.

17. The process according to claim 1, wherein the retarding deterioration of mouthfeel and texture flexibility (softness) of the composition comprising animal protein and starch is measured by a lower maximum breaking force as compared to the same product prepared without the use of an exogenous exoamylase, measured at least about 5 days, such as 10 days, such as 15 days, such as 20 days, such as 25 days, such as 30 days, such as 35 days, such as 40 days, such as 45 days, such as 50 days, such as 55 days, such as 60 days after the preparation of the composition comprising animal protein and starch.Novamyl

18. A composition obtained by the method according to claim 1.

19. The composition of claim 18, wherein the composition is a food product.
